(19) United States
(12) Patent Application Publication
(10) Pub. No.: US 2024/0086960 A1
(43) Pub. Date: Mar. 14, 2024

(54) INFORMATION PROCESSING DEVICE AND NOTIFICATION PROVISION METHOD

(71) Applicant: NEC Corporation, Minato-ku, Tokyo (JP)

(72) Inventor: Rumi Ikezawa, Tokyo (JP)

(73) Assignee: NEC Corporation, Minato-ku, Tokyo (JP)

(21) Appl. No.: 18/269,176

(22) PCT Filed: Dec. 25, 2020
(86) PCT No.: PCT/JP2020/048682

§ 371 Date: Jun. 22, 2023

(51) Int. Cl. G06Q 30/0207

(52) U.S. Cl. CPC G06Q 30/0222

(57) ABSTRACT

An information processing device according to an aspect of the present disclosure includes: at least one memory configured to store instructions; and at least one processor configured to execute the instructions to: determine whether a total amount of commodities registered on a portable terminal by an operation of a customer satisfies a coupon issuance condition for a target commodity; and notify the customer, before checkout of the commodities is completed, of the coupon issuance condition when the issuance condition is not satisfied.

### TECHNICAL FIELD

The present disclosure relates to an information processing device and the like.

### BACKGROUND ART

A commodity sales system in which a customer scans the barcode of a commodity and registers the commodity using a portable terminal such as a smartphone owned by the customer in a store is known. Such a system is referred to as a self-scanning shopping system. For example, PTL 1 discloses a self-scanning shopping system that displays a sales price on a portable terminal of a customer when the sales price is changed according to a predetermined condition such as package sale. PTL 1 discloses, for example, a set discount for a combination of specific commodities and a total amount discount that occurs when the total amount of purchased commodities is equal to or more than a predetermined amount.

### CITATION LIST

### Patent Literature

PTL 1: WO 2020-174881 A1

### SUMMARY OF INVENTION

### Technical Problem

By providing a set discount or a discount with respect to the total amount as in PTL 1, it is possible to increase the sales amount of commodities the store wants to sell or to increase the average customer spend. In general, in the retail industry, it is desirable to further increase both the sales amount of commodities and the average customer spend.

An object of the present disclosure is to provide an information processing device and the like that promotes sales of commodities that the store wants to sale and increases the average customer spend.

### Solution to Problem

An information processing device according to the present disclosure includes: a determination means that determines whether a total amount of commodities registered on a portable terminal by an operation of a customer satisfies a coupon issuance condition for a target commodity, and a notification means that notifies the customer before checkout of the commodities is completed, of the coupon issuance condition when the issuance condition is not satisfied.

A notification provision method according to the present disclosure includes: determining whether a total amount of commodities registered on a portable terminal by an operation of a customer satisfies a coupon issuance condition for a target commodity, and notifying the customer before checkout of the commodities is completed, of the coupon issuance condition when the issuance condition is not satisfied.

A program according to the present disclosure causes a computer to function as: a determination means that determines whether a total amount of commodities registered on a portable terminal by an operation of a customer satisfies a coupon issuance condition for a target commodity, and a notification means that notifies the customer before checkout of the commodities is completed, of the coupon issuance condition when the issuance condition is not satisfied.

### Advantageous Effects of Invention

According to the present disclosure, it is possible to increase the average customer spend.

### BRIEF DESCRIPTION OF DRAWINGS

FIG. 1 illustrates a configuration of an information processing system 1 according to a first example embodiment.

FIG. 2 is a block diagram illustrating one configuration example of a POS server 11.

FIG. 3 is a block diagram illustrating one configuration example of a customer terminal 12.

FIG. 4 is a block diagram illustrating one configuration example of a coupon notification device 10.

FIG. 5 is a flowchart illustrating an example of registration processing and notification processing of a coupon issuance condition.

FIG. 6 is a diagram illustrating an example of a commodity registration screen for scanning a commodity code.

FIG. 7 is a diagram illustrating an example of coupon information.

FIG. 8 is a diagram illustrating an example of a screen of a purchasing commodity list.

FIG. 9 is a diagram illustrating an example of coupon issuance notification.

FIG. 10 is a diagram illustrating a notification example of a coupon issuance condition.

FIG. 11 is a diagram illustrating another notification example of a coupon issuance condition.

FIG. 12 is a flowchart illustrating an example of checkout processing.

FIG. 13 is a diagram illustrating an example of other coupon information.

FIG. 14 is a diagram illustrating an example of other coupon information.

FIG. 15 is a diagram illustrating an example of other coupon information.

FIG. 16 is a diagram illustrating a configuration example of an information processing system 2 according to a modification.

FIG. 17 is a diagram illustrating an example of a checkout code.

FIG. 18 is a diagram illustrating a configuration example of an information processing system 3 according to a modification.

FIG. 19A is a diagram illustrating a configuration example of an information processing device 50 according to a second example embodiment.

FIG. 19B is a flowchart illustrating a basic operation of the information processing device 50.

FIG. 20 is a diagram illustrating a hardware configuration example of a computer 31.

FIG. 21 is a diagram illustrating a hardware configuration example of a customer terminal 32.

### EXAMPLE EMBODIMENT

Hereinafter, example embodiments of an information processing device, a coupon notification device, a method, a program, and a recording medium recording the program according to the present disclosure will be described in detail with reference to the drawings. The present example embodiment does not limit the disclosed technology.

### First Example Embodiment

[Configuration]

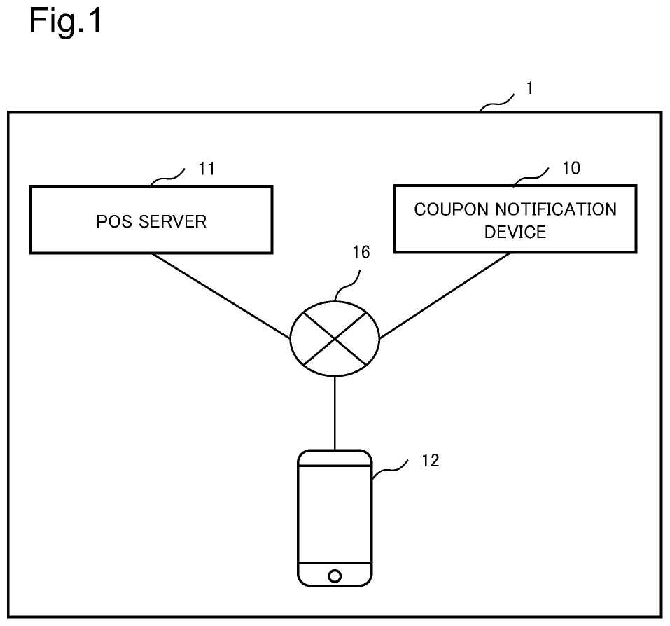

FIG. 1 illustrates a configuration of an information processing system 1 according to a first example embodiment. The information processing system 1 includes a coupon notification device 10, a Point of Sales (POS) server 11, and a customer terminal 12. The coupon notification device 10, the POS server 11, and the customer terminal 12 may be connected via, for example, a communication network 16.

In the first example embodiment, a customer performs self-scanning shopping. Specifically, the customer acquires a commodity from a shelf or the like in a store, and registers the commodity using the customer terminal 12. The customer terminal 12 is a terminal used by the customer. The customer terminal 12 is, for example, a portable terminal such as a smartphone or a tablet. The type of the customer terminal 12 is not particularly limited. The customer terminal 12 may be owned by the customer or lent out at a store. The customer terminal 12 may be attached to a shopping basket or a shopping cart, or may be provided integrally with the shopping basket or the shopping cart. The device having the function of the customer terminal 12 includes a portable terminal, a movable terminal, a transportable terminal, a mobile terminal, and a mobile body.

The coupon notification device 10 notifies the customer by notifying the customer terminal 12 of information regarding an electronic coupon. An issuance condition is set for the coupon. The coupon notification device 10 notifies the customer of, for example, a coupon issuance condition as information regarding the coupon. The total amount of the registered commodities is set as the issuance condition. When the coupon is applied, the price of a target commodity is lowered. One type of coupon lowers the price of one or a plurality of types of target commodities. A plurality of types of coupons can be prepared for each target commodity.

In a case where the total amount of registered commodities does not satisfy the coupon issuance condition, when the customer is notified of the coupon issuance condition, the customer additionally registers the commodity to satisfy the issuance condition. When the total amount satisfies the issuance condition, the coupon is applied, and the customer can purchase the target commodity of the coupon at a lower price than before the application of the coupon.

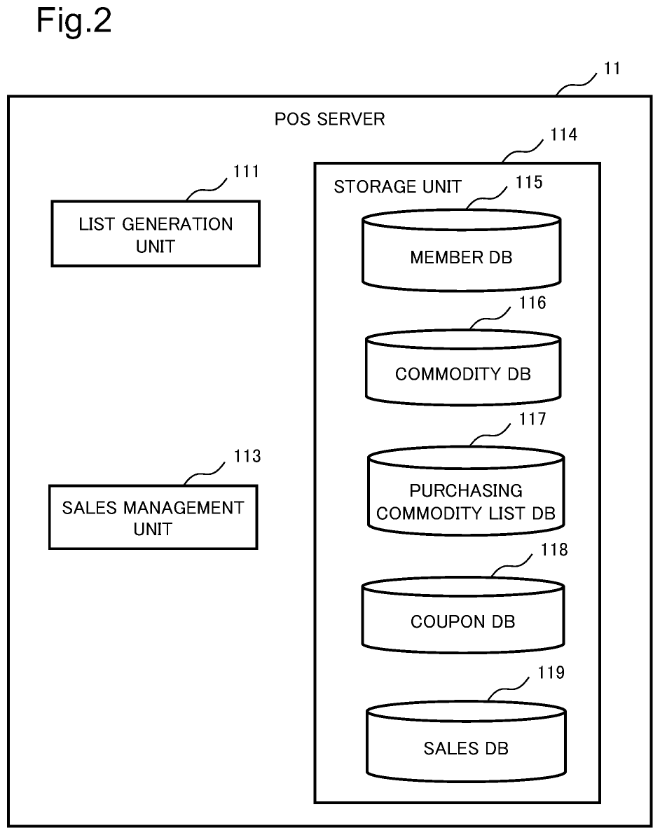

One configuration example of each device according to the first example embodiment will be described with reference to FIGS. 2 to 4.

FIG. 2 is a block diagram illustrating one configuration example of the POS server 11. The POS server 11 includes a list generation unit 111, a sales management unit 113, and a storage unit 114.

The POS server 11 is a server that manages various sales information such as a price regarding commodities to be sold in the store, an inventory status, and sales information of a store. The POS server 11 may collectively manage the sales information of a plurality of stores. Alternatively, the POS server 11 may exist for each store. Then, the POS server 11 may manage the sales information of one store.

Further, the POS server 11 may perform processing according to a request from the customer terminal 12. For example, the POS server 11 may transmit information necessary for display control of the customer terminal 12 to the customer terminal 12. For example, the POS server 11 may transmit, to the customer terminal 12, information of a screen displaying the commodity to be purchased registered by the customer terminal 12 together with the price. The registered commodity to be purchased is hereinafter referred to as a “purchasing commodity”. The purchasing commodity is one example embodiment of “commodities registered on the customer terminal 12 by an operation of a customer”. The purchasing commodity is one example embodiment of “commodities registered in association with a customer”. Hereinafter, the list including purchasing commodities and their prices is referred to as a “purchasing commodity list”. The POS server 11 may manage information regarding a customer registered as a member of the store.

Here, an example in which the POS server 11 is achieved by one device will be described. However, an achievement example of the POS server 11 is not particularly limited. The POS server 11 may be achieved by different devices for each function or database (DB).

The list generation unit 111 generates a purchasing commodity list for each customer. Specifically, the list generation unit 111 generates a purchasing commodity list in which information for identifying a customer, commodity information of a commodity to be purchased by the customer, and a purchase quantity are associated with each other, and causes a purchasing commodity list DB 117 to store the purchasing commodity list.

The purchasing commodity list is uniquely identified by the information for identifying the customer. The information for identifying the customer is, for example, a customer ID for uniquely identifying the customer. For example, when registration of the commodity of the customer is started, the list generation unit 111 assigns a customer ID to the customer. When a period from the start of registration to the end of checkout is defined as one transaction, the customer ID may be assigned for each transaction.

The commodity information included in the purchasing commodity list includes information capable of uniquely identifying a commodity, such as a commodity ID. The commodity information of the purchasing commodity list includes a before-tax commodity price or a tax-inclusive commodity price.

In a case where there is a coupon applicable to the registered commodity, the purchasing commodity list may include information regarding the coupon associated with the commodity information of the commodity. The information regarding the coupon is, for example, a commodity price after coupon application, a discount amount, or a discount rate.

The list generation unit 111 updates the purchasing commodity list based on an update request from the customer terminal 12. Specifically, the list generation unit 111 adds or deletes the commodity included in the purchasing commodity list based on the commodity information included in the update request.

When the registration of the commodity is completed, the sales management unit 113 generates checkout information used for checkout. The checkout information includes at least information regarding the total payment amount for the commodity registered in the purchasing commodity list. Specifically, the checkout information may be the total payment amount itself, or the commodity information, the quantity and the like necessary for calculating the total payment amount. The checkout information may further include a commodity name of a purchasing commodity, a total number of purchasing commodities, information regarding a coupon to be applied, or information for identifying checkout. The sales management unit 113 may generate the purchasing commodity list in which registration of commodities is completed as the checkout information. The customer ID described above may be used as the information for identifying the checkout. For example, the sales management unit 113 updates a sales DB 119 according to the content of checkout.

The storage unit 114 stores, for example, data used for processing of each unit of the POS server 11. Examples of the storage unit include read only memory (ROM), random access memory (RAM), semiconductor memory, a hard disk drive (HDD), and a solid state drive (SSD). The storage unit 114 may be a combination thereof. The storage unit 114 includes a member DB 115, a commodity DB 116, the purchasing commodity list DB 117, a coupon DB 118, and the sales DB 119.

The member DB 115 stores, for example, member information for each member (customer). The member information is, for example, information of at least one of a member identifier (ID), a name of the member, a sex of the member, an age or an age group of the member, a member rank, and a contact of the member. The member ID is, for example, an identifier for uniquely identifying the member. The type of the member ID is not particularly limited. The member ID may be represented by a member number. The member rank is determined according to, for example, the number of times of use of the store, the frequency of use, the amount of use, and the like. The contact is a contact such as an email address, a telephone number, or the like.

The member DB 115 may further store information such as a password, a past purchase history, and points for each member. The member DB 115 may further store the biological information for each member. The biological information is not particularly limited. Examples of the biological information include face feature amount information, face image data, fingerprint data, iris data, vein data, and the like. Further, the member DB may store the ID of the customer terminal 12 used by the customer. In the case of the customer terminal 12 lent from the store for self-scanning, the ID of the customer terminal 12 is deleted from the member DB after the checkout of the purchasing commodity is completed.

The member DB 115 may include payment information used for electronic payment. Examples of the electronic payment include at least one of credit payment, debit payment, electronic money payment, point payment, and cryptocurrency payment. The payment information is, for example, a credit card number.

The member DB 115 may not include a part of the above-described information regarding the member. The member DB 115 may include information other than the above-described information regarding the member.

The commodity DB 116 stores commodity information of commodities handled in a store or an affiliated store including the store. Specifically, the commodity DB 116 stores, for example, commodity information for each commodity. The commodity information stored in the commodity DB 116 is, for example, information such as a commodity ID, a commodity name, a classification of commodity, a price of commodity, a characteristic of commodity, and an inventory status of commodity. The commodity ID is, for example, the code of a commodity (hereinafter referred to as a commodity code). The commodity code is at least one of a Japanese Article Number (JAN) code, a European Article Number (EAN) code, and a Universal Product Code (UPC). The commodity ID may be a commodity name. The classification of commodity is not particularly limited. For example, the classification of commodity may be rough classification into, for example, food, stationery, and the like. The classification of commodity may be a classification of confectionery, meat, vegetable, and the like. The price of commodity is the unit price of a commodity before the price reduction by the coupon is applied. The characteristic of commodity is not particularly limited. The characteristic of commodity may be a best-before date, a use-by date, a manufacturer name, a vendor name, or the like. The inventory status of commodity may be an inventory quantity of commodities, an inventory position of commodities, or the like.

The commodity information may include information for identifying the commodity in addition to the commodity ID. For example, the commodity information may include image data of a commodity, information of the feature amount obtained from the image data of the commodity, or the like.

The commodity DB 116 may not include a part of the above-described information regarding the commodity. The commodity DB 116 may include information other than the above-described information regarding the commodity.

The purchasing commodity list DB 117 stores, for each customer, the latest purchasing commodity list for which checkout has not been ended. The member ID may be used as the customer ID for uniquely identifying the purchasing commodity list. Alternatively, the purchasing commodity list DB 117 may store the customer ID and the member ID in association with each other. The price of the commodity is obtained from the commodity DB 116 based on the commodity ID of the purchasing commodity list. The purchasing commodity list DB 117 may store the tax-inclusive commodity price calculated based on the before-tax commodity price acquired from the commodity DB 116.

The purchasing commodity list DB 117 may not include a part of the above-described information regarding the purchasing commodity list. The purchasing commodity list DB 117 may include information other than the above-described information regarding the purchasing commodity list.

The coupon DB 118 stores, for example, coupon information regarding one or more coupons to be issued to the customer. The coupon information includes, for example, a coupon issuance condition, target commodity information, and price reduction information for each coupon.

The coupon issuance condition includes that the total amount of purchasing commodities for each customer is equal to or more than a preset amount. The total amount of purchasing commodities may be the sum of before-tax prices or the sum of tax-inclusive prices.

The information of the target commodity is information for identifying a commodity to which a price reduction is applied when an issuance condition is satisfied. The information of the target commodity is, for example, a commodity name or a commodity ID. The information of the target commodity may further include an image, a price, or an inventory position of the commodity.

The price reduction information is, for example, information regarding a discount amount, a discount rate, or a price after the coupon is applied. The information of the discount amount indicates, for example, an amount to be subtracted from the price of the target commodity when the issuance condition is satisfied. The coupon may reduce the price from a tax-inclusive price or may reduce the price from a before-tax price.

The coupon information may be determined for each attribute of the customer. Examples of the attribute of the customer include age, sex, member rank, and family structure of the customer. Specifically, for example, the coupon issuance condition regarding the total amount, the target commodity, and the discount amount or discount rate may be determined according to the attribute of the customer.

The coupon information may be determined for each customer. The coupon information may be determined based on a purchase history of the customer. For example, the same commodity as a commodity purchased by the customer in the past, a similar commodity (for example, a higher-grade commodity than before), or another related commodity may be determined as the target commodity based on the purchase history of the customer. The issuance condition regarding the total amount may be determined with reference to the payment amount of the past transaction.

By determining coupon information for each attribute of a customer or for each customer, it is possible to effectively issue a coupon as compared with a case where a coupon is uniformly distributed to all customers.

The coupon information may be stored based on an input of a store manager, or may be generated and stored by the POS server 11. The POS server 11 may generate and update the coupon information based on, for example, a date, a day of the week, a time, a target number of sales, an inventory status, a best-before date and a use-by date of a commodity, and the like. The coupon information may be delivered to the customer terminal 12 so as to be viewed by the customer.

The sales DB 119 stores, for example, information regarding store sales for each store. For example, the sales DB 119 may manage information according to each checkout for each store. The sales DB 119 stores, for example, each piece of information of a store ID, an ID of the customer terminal 12 that has performed commodity registration, a member ID of a user of the device, a commodity ID of a purchased commodity, a purchase quantity, a sales price, and a purchase date and time in association with each other. The store ID is an identifier for uniquely identifying the store.

The sales DB 119 may not include a part of the above-described information regarding the sales. The sales DB 119 may include information other than the above-described information regarding the sales.

For example, the sales management unit 113 updates a sales DB 119 according to the content of checkout. For example, the sales DB 119 and the commodity DB 116 are associated with each other by the commodity ID. For example, the POS server 11 may update the inventory status of the commodity DB 116 based on the information of the purchase quantity registered in the sales DB 119.

The POS server 11 may not include some of the functional units. The POS server 11 may include a functional unit, which is not illustrated. The functional units of the POS server 11 illustrated in FIG. 2 may be achieved by a plurality of devices. For example, each functional unit may be achieved by two devices including the list generation unit 111 and the sales management unit 113.

For ease of description and understanding, an example in which the POS server 11 includes various DBs will be described, but it is not limited thereto. For example, the various DBs may be included in different devices. For example, a server that manages the sales DB 119, a server that manages the member DB 115, and a server that manages the purchasing commodity list DB 117 may be different from each other. In such a case, the server that manages the sales DB 119 and the server that manages the member DB 115 function as a database server. The server that manages the purchasing commodity list DB 117 functions as, for example, an application server. Some or all of the various DBs may be included in the coupon notification device 10. Each server passes information to be used for the assigned processing via, for example, the communication network 16 or the like.

The POS server 11 may handle various types of information, which is not illustrated. For example, the POS server 11 may acquire information regarding a change in price such as bundle discount, set discount, classification discount, and the like, and perform the checkout processing using the information. Alternatively, the POS server 11 may update the purchasing commodity list using the information. The bundle discount is a discount given when a plurality of specific commodities is purchased. The set discount is a discount for a combination of specific commodities. The classification discount is a discount for a commodity belonging to a specific classification (for example, frozen food). The issuance condition regarding the total amount may be the sum of the amounts of the commodities before a change in price such as bundle discount, set discount, classification discount, or the like is applied, or the sum of the amounts of the commodities after the application.

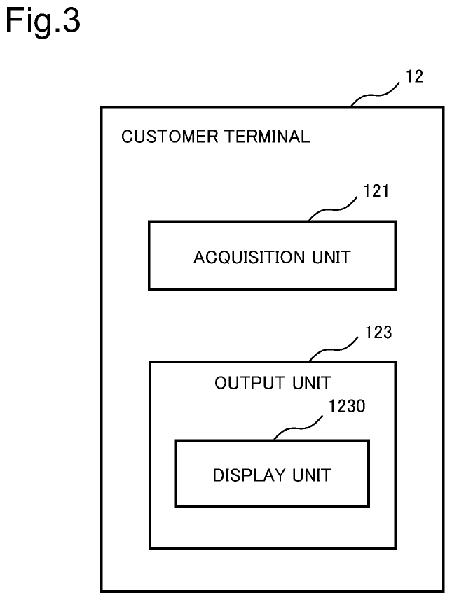

FIG. 3 is a block diagram illustrating one configuration example of the customer terminal 12. The customer terminal 12 includes an acquisition unit 121 and an output unit 123. The output unit 123 includes a display unit 1230. A storage unit, which is not illustrated, of the customer terminal 12 stores the member ID and the identifier for identifying the customer terminal 12.

The acquisition unit 121 acquires the commodity ID of the commodity selected by the customer, transmits an update request including the commodity ID to the POS server 11, and causes the POS server 11 to register the commodity as a purchasing commodity.

The acquisition unit 121 acquires the commodity ID of the purchasing commodity by reading the commodity code attached to the commodity or the like via, for example, an imaging device, which is not illustrated. The imaging device is not particularly limited, and is, for example, a camera included in the customer terminal 12. The commodity code is the above-described JAN code or the like. The imaging device reads an encoded commodity code such as a barcode or a two-dimensional code. For example, the acquisition unit 121 may acquire the commodity ID by identifying the commodity using an image recognition function from the image of the commodity captured by the imaging device.

The acquisition unit 121 may acquire the commodity ID by reading a commodity image captured in advance or an image of a picture of a commodity via the imaging device. These images may include the commodity code.

The acquisition unit 121 may acquire the commodity ID by scanning, with a reading device, a tag to which a radio frequency identifier (RFID) is attached. When RFID is used, the reading device is an RFID reader.

The acquisition unit 121 may acquire the commodity ID by receiving selection of a commodity from a result of commodity search. For example, a commodity search method is not particularly limited. The commodity search may be performed using characters. The commodity search may be performed using an image. For example, the acquisition unit 121 may acquire the commodity ID by receiving selection of a commodity to be purchased from the displayed commodity image.

The acquisition unit 121 may acquire the commodity ID by receiving an input of the number of a JAN code via an input device, which is not illustrated. Examples of the input device include a touch panel display and a keyboard capable of inputting numbers and characters.

The output unit 123 transmits the commodity ID acquired by the acquisition unit 121 to the POS server 11. At this time, the output unit 123 also transmits the member ID or the identifier for identifying the customer terminal 12 to the POS server 11. The customer terminal 12 may receive the name and the price of the commodity corresponding to the transmitted commodity ID from the POS server 11. At this time, the display unit 1230 displays the name and price of the commodity.

The display unit 1230 displays the purchasing commodity list received from the POS server 11. The display unit 1230 displays the information regarding coupon received from the coupon notification device 10.

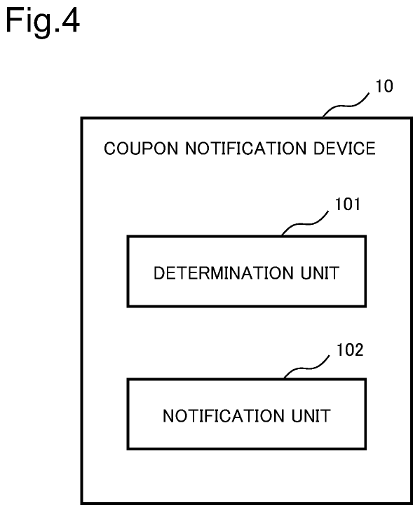

FIG. 4 is a block diagram illustrating one configuration example of the coupon notification device 10. The coupon notification device 10 includes a determination unit 101 and a notification unit 102.

The determination unit 101 determines whether the total amount of commodities registered in association with the customer satisfies the coupon issuance condition for a target commodity. Specifically, when the purchasing commodity list is updated, the determination unit 101 receives the purchasing commodity list from the POS server 11. The determination unit 101 refers to the coupon DB 118 and determines whether the total amount of purchasing commodities satisfies the coupon issuance condition stored in the coupon DB 118.

More specifically, for example, the determination unit 101 refers to the coupon DB 118 and determines whether the target commodity of any coupon is included in the purchasing commodity list. When there is a target commodity, the determination unit 101 determines whether the total amount of purchasing commodities satisfies the coupon issuance condition for the target commodity. In a case where the issuance condition is satisfied, the determination unit 101 may determine that there is a coupon to be issued. When the target commodity of the coupon is not included in the purchasing commodity list or when the total amount of purchasing commodities does not satisfy the coupon issuance condition, the determination unit 101 may determine that there is no coupon to be issued. The determination unit 101 may transmit the determination result to the POS server 11.

When the total amount does not satisfy the issuance condition, the notification unit 102 notifies the customer before checkout of purchasing commodities is completed, of the coupon issuance condition. Specifically, for example, the notification unit 102 notifies the customer by transmitting coupon information to the customer terminal 12. The coupon information includes the coupon issuance condition, the information of the target commodity, and the price reduction information. The information of the target commodity is, for example, any of the commodity name, the image of the commodity, and the inventory position of the commodity. The customer terminal 12 displays the received coupon information. For example, it is assumed that the customer before the checkout is completed is in a shopping area in which commodities are displayed. Therefore, the customer who has received the notification may add a purchasing commodity. In a case where there is a plurality of coupons for which the issuance conditions are not satisfied, the notification unit 102 may give a notification of a plurality of coupon issuance conditions.

[Operation]

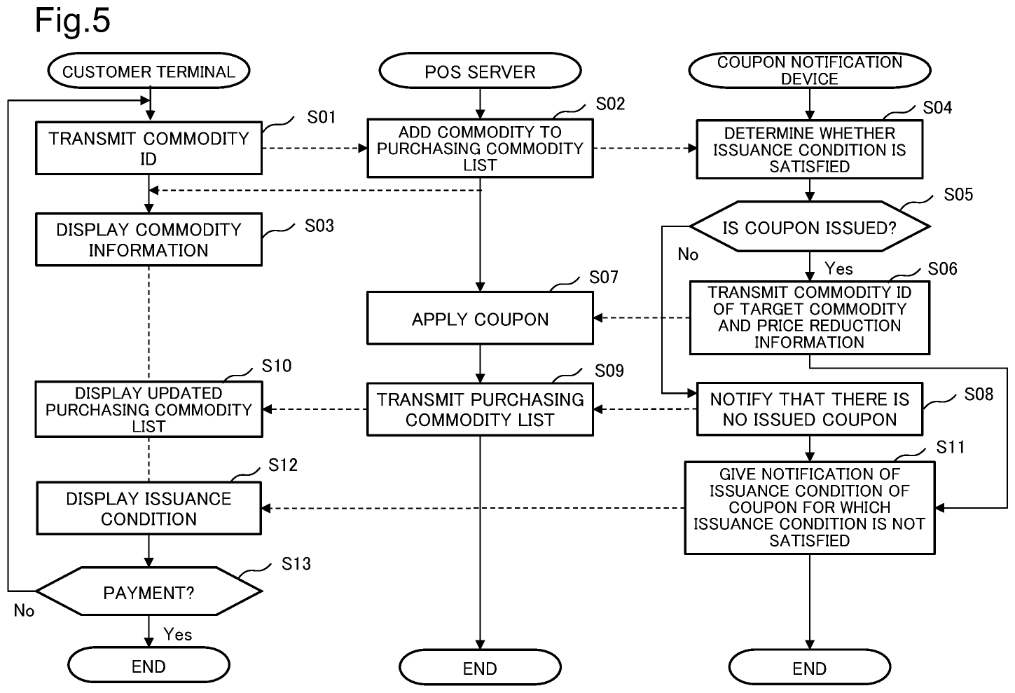

Hereinafter, an operation example of the information processing system 1 according to the first example embodiment will be described with reference to the drawings. FIG. 5 is a flowchart illustrating an example of registration processing and notification processing of a coupon issuance condition.

1. Registration of Commodity

The acquisition unit 121 of the customer terminal 12 acquires the commodity ID of the purchasing commodity by reading the commodity code attached to the commodity or the like, and the customer terminal 12 transmits an update request including the commodity ID to the POS server 11 (step S01). The update request may include the member ID of the customer, the ID of the customer terminal 12, and the like in addition to the commodity ID.

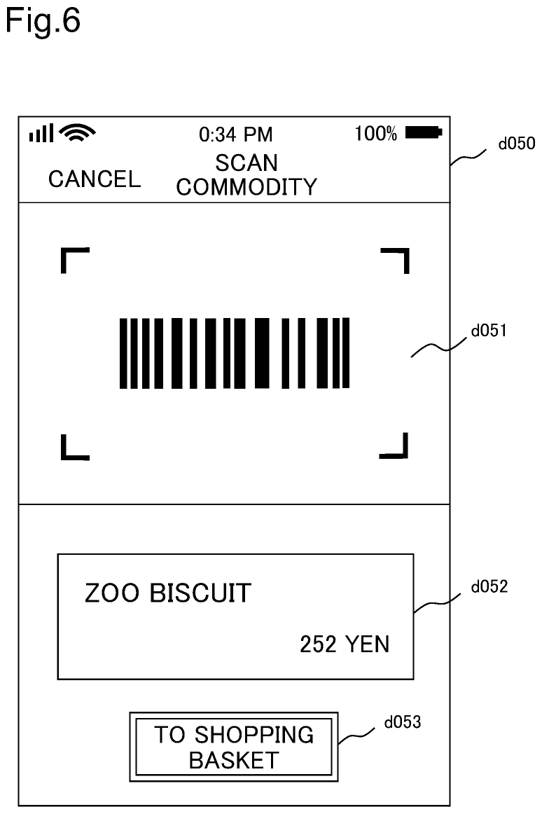

FIG. 6 is a diagram illustrating an example of a commodity registration screen for scanning a commodity code. The display unit 1230 of the customer terminal 12 displays a screen d050 for scanning the commodity code. For example, the screen d050 includes a portion to be scanned d051, a display field d052 that displays information of a read commodity, and a button d053 that displays “to shopping basket” for displaying the purchasing commodity list. When the commodity code of the imaged commodity is located in a predetermined area of the portion to be scanned d051, the acquisition unit 121 acquires the commodity ID of the purchasing commodity.

Referring back to FIG. 5, the list generation unit 111 of the POS server 11 adds the commodity included in the update request to the purchasing commodity list of the customer (step S02). The POS server 11 transmits the commodity information of the commodity the commodity ID has been acquired, to the customer terminal 12. The customer terminal 12 displays the received commodity information (step S03). For example, in FIG. 6, in the display field d052, “ZOO biscuit” as the name of the commodity and 252 yen as the price of the commodity are displayed among the received commodity information.

2. When Coupon is Issued

Referring back to FIG. 5, when the commodity is added to the purchasing commodity list in step S02, the POS server 11 transmits the purchasing commodity list to the coupon notification device 10. The determination unit 101 of the coupon notification device 10 determines whether the purchasing commodity list satisfies the coupon issuance condition (step S04). When the total amount satisfies the issuance condition and the coupon is issued (step S05: Yes), the determination unit 101 transmits the commodity ID of the target commodity of the coupon and the price reduction information to the POS server 11 as a determination result (step S06). The list generation unit 111 applies the coupon to the purchasing commodity list based on the received determination result (step S07). Specifically, for example, the list generation unit 111 causes the purchasing commodity list DB 117 to store the commodity registered in the purchasing commodity list in association with the information regarding the coupon. The list generation unit 111 transmits the updated purchasing commodity list to the customer terminal 12.

The customer terminal 12 displays the updated purchasing commodity list (step S09). Specifically, the customer terminal 12 displays the purchasing commodity list to which the commodity is added and on which the price reduction information of the target commodity is displayed.

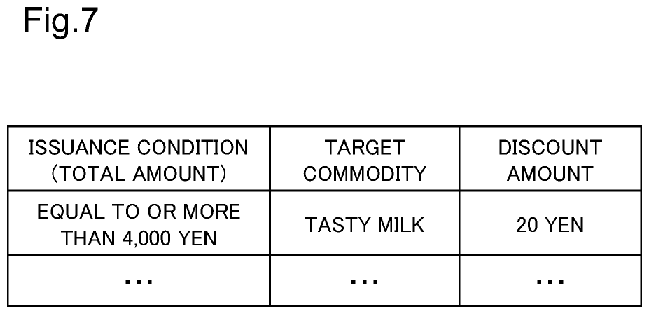

FIG. 7 is a diagram illustrating an example of coupon information stored in the coupon DB 118. The coupon information of FIG. 7 includes information of a coupon for “tasty milk”, which is a commodity of a certain company, as a target commodity. The coupon issuance condition is that the total amount of purchasing commodities is equal to or more than 4000 yen. The discount amount in a case where the coupon is applied is “20 yen” per target commodity.

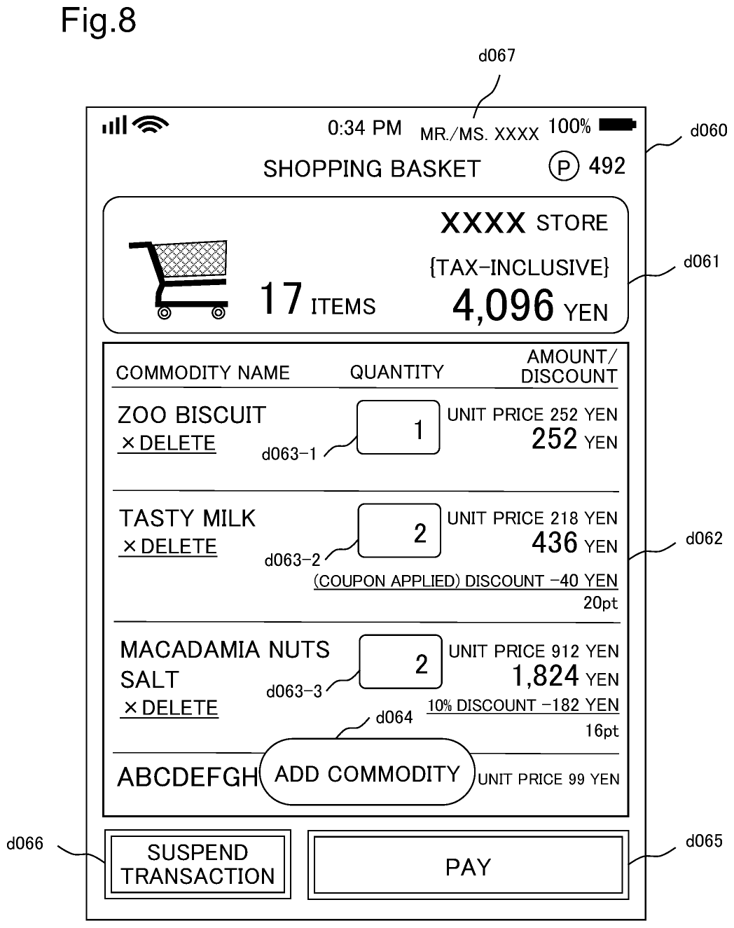

FIG. 8 is a diagram illustrating an example of a screen of the purchasing commodity list displayed on the customer terminal 12. A screen d060 includes, for example, a summary field d061 of the purchasing commodity list, a description field d062, a commodity addition button d064, a payment button d065, a transaction suspension button d066, and an operator name display field d067. In the summary field d061, for example, information such as the total quantity of commodities registered in the purchasing commodity list, the amount to be paid, and the store name is displayed. The amount to be paid is, for example, an amount after the price reduction by the coupon is applied to the total amount of tax-inclusive sales prices. In the description field d062, for example, information such as the name of the commodity registered in the purchasing commodity list, the purchase quantity, the unit price before discount, the price obtained by multiplying the unit price before discount by the purchase quantity, the discount rate, and the discount amount is displayed for each commodity. For example, the description field d062 may have a purchase quantity input field d063 for each commodity. In the description field d062, for example, the commodity information may be displayed in order of newest registration. In the description field d062, for example, the commodity information display order can be designated.

When the coupon issuance condition is satisfied, the display unit 1230 of the customer terminal 12 displays, for example, the screen d060 illustrated in FIG. 8. The description field d062 indicates that the coupon is applied to each of two cartons of “tasty milk” and the discount amount is “40 yen”.

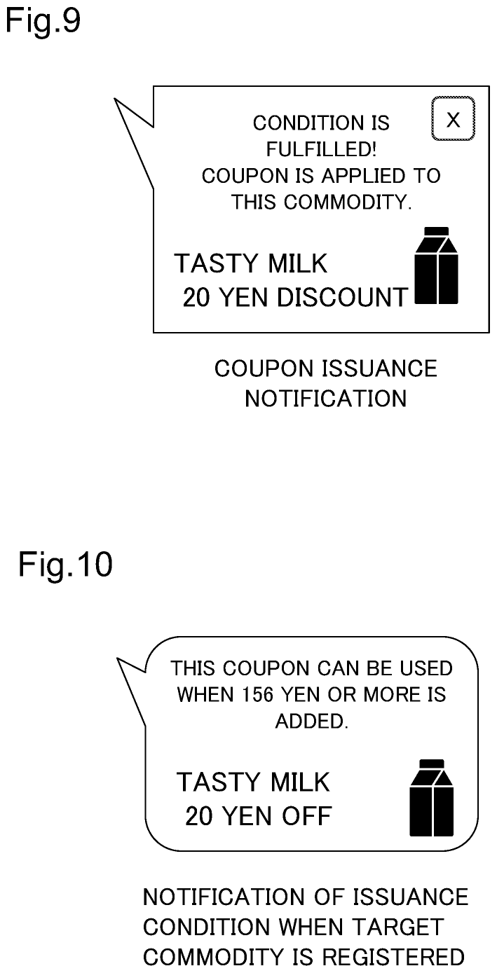

For example, it is assumed that, in a state where two cartons of “tasty milk” that are target commodities are registered, the total amount of purchasing commodities does not satisfy the issuance condition (in the case of less than 4000 yen). From this state, it is assumed that “ZOO biscuit” illustrated in FIG. 6 is registered and the issuance condition is satisfied. At this time, the display unit 1230 of the customer terminal 12 may display the coupon issuance notification. The coupon issuance notification notifies that the coupon has been issued. FIG. 9 is a diagram illustrating an example of coupon issuance notification. The notification of FIG. 9 includes the target commodity name of the applied coupon, the discount amount, and the image of the commodity. The notification of FIG. 9 may be displayed by being superimposed on the screen of d050 of FIG. 6 or the screen d060 of FIG. 8. For example, the notification of FIG. 9 may be displayed in association with the coupon target commodity displayed in the description field d062 of FIG. 8.

3. When Coupon is not Issued

Referring back to FIG. 5, when there is no target commodity or when the total amount does not reach the issuance condition amount (step S05: No), the determination unit 101 determines that no coupon is issued. In this case, the determination unit 101 transmits, to the POS server 11, that there is no issued coupon as a result of determination. When receiving the determination result, the POS server 11 transmits the updated purchasing commodity list to the customer terminal 12 (step S09).

The customer terminal 12 displays the updated purchasing commodity list (step S10). Specifically, the customer terminal 12 displays the purchasing commodity list to which the commodity the commodity ID has been acquired has been added.

4. Notification of Issuance Condition

After the determination unit 101 of the coupon notification device determines whether the total amount of purchasing commodities satisfies the issuance condition, the notification unit 102 notifies the customer terminal 12 of the issuance condition of the coupon for which the issuance condition is not satisfied (step S11). When one coupon is issued, the notification unit 102 may give a notification of the issuance condition of another coupon for which the issuance condition is not satisfied. Upon receiving the notification, the customer terminal 12 displays the coupon issuance condition on the display unit 1230 (step S12).

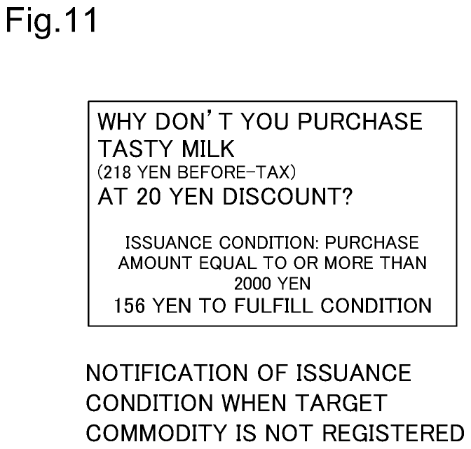

FIGS. 10 and 11 are diagrams illustrating notification examples of coupon issuance conditions displayed on the display unit 1230. FIG. 10 is an example of the coupon issuance condition displayed when the target commodity is registered in the purchasing commodity list. The image of FIG. 10 gives a notification of the difference between the total amount of purchasing commodities and the total amount of the issuance condition as the issuance condition. For example, the notification of FIG. 10 may be displayed in association with the coupon target commodity displayed in the description field d062 of FIG. 8. The notification unit 102 may give a notification of the issuance condition of a coupon for a commodity added to the purchasing commodities among a plurality of coupons. FIG. 11 is an example of the issuance condition displayed when the target commodity is not registered in the purchasing commodity list. The notification unit 102 may give a notification of the issuance condition of a coupon for which the issuance condition is satisfied by adding the target commodity. The notifications of the issuance conditions in FIGS. 10 and 11 are displayed before the checkout is completed. Each of the images of FIGS. 10 and 11 may be displayed by being superimposed on the screen of d050 of FIG. 6 or the screen of d060 of FIG. 8.

The images of FIGS. 10 and 11 give a notification of the target commodity name together with the coupon issuance condition. However, the notification to the customer may not include the target commodity name. For example, when target commodities of a plurality of coupons for which the same issuance condition is set belong to the same classification, it is sufficient if the customer is notified of the issuance condition and the classification name.

The coupon issuance notification as illustrated in FIG. 9 and the notifications of the issuance conditions in FIGS. 10 and 11 may be displayed in different forms. For example, the coupon issuance notification and the notification of the issuance condition may be displayed in different colors. By displaying in different colors, the customer can distinguish between the coupon issuance notification and the notification of the issuance condition.

5. End of Registration Processing

When payment is not performed (step S13: No), the customer terminal 12 returns to step S01. When payment is performed (step S13: Yes), the customer terminal 12 ends the registration processing and proceeds to the checkout processing. For example, in FIG. 8, when the payment button d065 is pressed, the customer terminal 12 ends the registration of the commodity.

6. Checkout

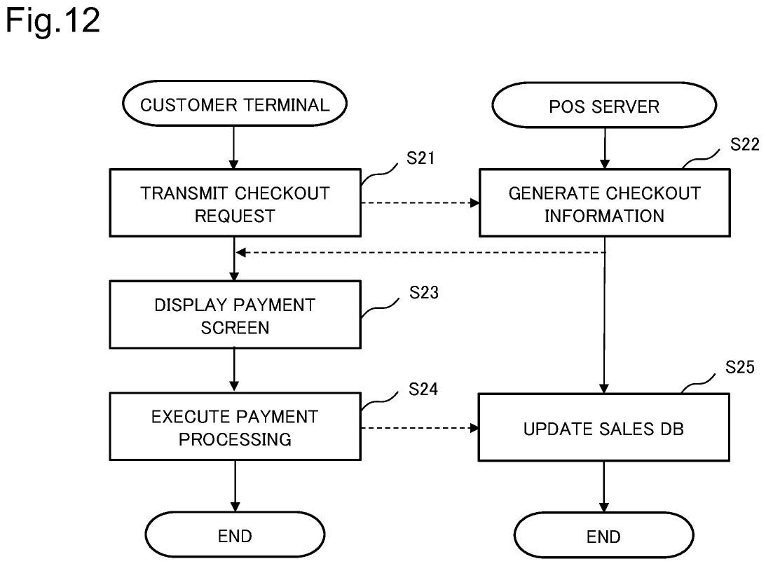

FIG. 12 is a flowchart illustrating an example of checkout processing. The customer terminal 12 transmits a checkout request to the POS server 11 (step S21). The sales management unit 113 of the POS server 11 generates checkout information (step S22) and transmits the checkout information to the customer terminal 12. The checkout information includes, for example, a total payment amount for purchasing commodities. The customer terminal 12 displays a payment screen (step S23). The payment screen may display payment information such as the total number of purchasing commodities, the total payment amount for the purchasing commodities, and the last four digits of the credit card number used for electronic payment. The payment screen may display a payment processing execution button. The customer terminal 12 communicates with a payment server, which is not illustrated, using payment information such as a credit card number stored in the member DB 115, and executes the payment processing (step S24). The customer terminal 12 transmits completion of the payment processing to the POS server 11. When the completion of the payment processing is received, the sales management unit 113 of the POS server 11 updates the sales DB 119. Thus, the information processing system 1 ends the checkout processing.

Thus, the description of the operation example of the information processing system 1 according to the first example embodiment ends. In the above operation example, the case where the payment information stored in the member DB 115 is used has been described, but the customer terminal 12 may ask the customer to input the payment information every time checkout is performed.

In the above operation example, the case where the coupon is applied immediately when the coupon issuance condition is satisfied has been described. Therefore, the issuance condition may also be referred to as an application condition. However, after the issuance condition is satisfied and the coupon is issued, it may be applied based on an operation of the customer or the store clerk. For example, in a case where the issuance condition regarding the total amount of the registered commodities is satisfied, the coupon is electronically issued and distributed to the customer electronically or by paper. For example, when a digital coupon is delivered to the customer terminal 12, the customer operates the customer terminal 12 and applies the coupon before the checkout is completed. When the coupon is applied, the price of the target commodity registered in the purchasing commodity list is lowered. The issued coupon may be a coupon of a type applied in the next shopping.

[Effects]

According to the first example embodiment, it is possible to propose to the customer to increase the total amount of purchasing commodities. This is because a coupon having an issuance condition regarding the total amount of purchasing commodities is issued. This is because the notification unit 102 of the coupon notification device 10 notifies the customer before the checkout is completed, of the coupon issuance condition. By notifying the customer of the coupon issuance condition, it is possible to encourage the customer to add a purchasing commodity to satisfy the issuance condition.

According to the first example embodiment, it is possible to promote the sale of commodities suitable for the purpose of the store, such as commodities close to the best-before date or the use-by date, commodities with a large stock, seasonal commodities, and commodities with a high profit margin. This is because when the coupon is applied, the price of the target commodity is lowered. The store sets a commodity the store wants to sell as a target commodity of the coupon. The customer who has received the notification of the target commodity of the coupon adds the target commodity as a purchasing commodity. The customer who has received the notification of the target commodity or the issuance condition of the coupon the target commodity of which is the registered commodity considers not to deregister the target commodity. Alternatively, it is considered to further add a target commodity. Therefore, the sales amount of target commodities may be increased.

Even when a notification regarding a discount of a commodity or a notification of a coupon having no issuance condition regarding the total amount is given, only the sales amount of the commodity increases, and the average customer spend cannot be increased. In a case where the total amount of the registered commodities is equal to or more than a predetermined amount, even when a discount is given to the entire purchasing commodities, it is not possible to promote the sales of the commodities that the store wants to sell. According to the first example embodiment, there is a case where the number of notifications to be given to the customer can be reduced as compared with a case where a notification for promoting sales of a commodity that the store wants to sell is given and a notification for increasing the average customer spend is given. This is because the notification unit 102 notifies the customer of the issuance condition regarding the total amount of the coupons of the target commodities. When a coupon is issued while a customer is shopping and the coupon is can be used at the time of the shopping, it is possible to promote the sales amount of a target commodity in the customer's shopping and to increase the average customer spend.

[Modification: Issuance of Coupon According to Location]

The issuance condition stored in the coupon DB 118 may further include that the customer is in a predetermined area in the store. For example, the issuance condition may include that the customer is at a predetermined location in the store. The location of the customer terminal 12 in the store may be detected by Wi-Fi, a beacon, or a sensor of the customer terminal 12 such as a magnetometer, an accelerometer, or a gyroscope, and used as the location of the customer in the store. In this case, the location information detected by the customer terminal 12 is transmitted to the POS server 11. Further, the location where the member ID or biological information of the customer is detected may be used using a non-contact IC chip reader/writer, a card reader/writer, a barcode reader, or a sensor such as a camera installed in the display area. The determination unit 101 of the coupon notification device 10 receives the location of the customer in the store from the POS server 11, and determines whether the location of the customer in the store satisfies the issuance condition.

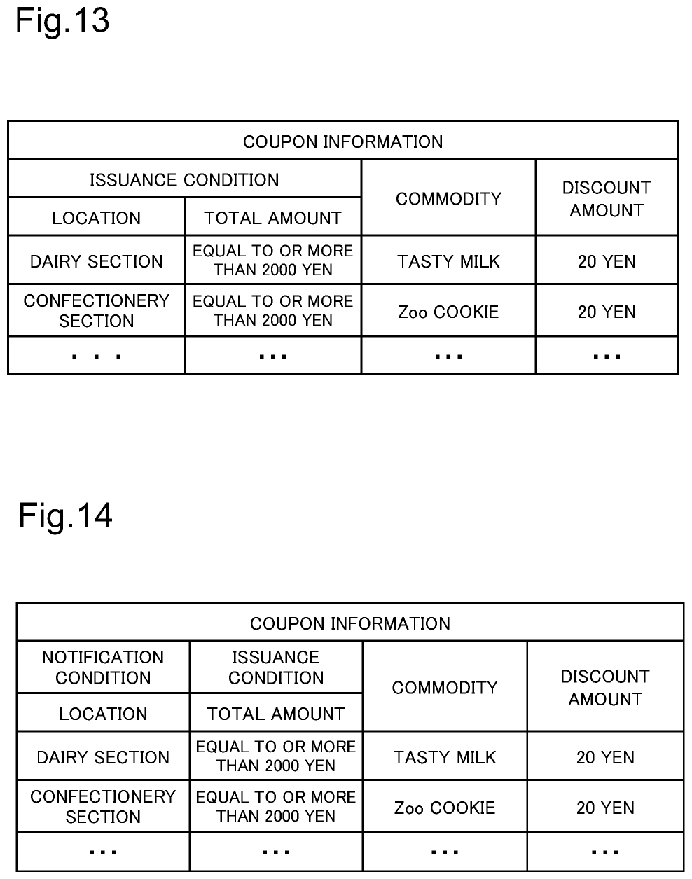

FIG. 13 is a diagram illustrating an example of coupon information according to the present modification. In the coupon information illustrated in FIG. 13, in addition to the issuance condition of the total amount illustrated in FIG. 7, the issuance condition of the location is associated with the target commodity and the discount amount. Here, the location means an area where the customer exists as one of the issuance conditions. In the example of FIG. 13, a coupon in which “tasty milk” is discounted by 20 yen is issued on condition that the total amount of purchasing commodities of the customer is equal to or more than 2000 yen and the customer is in the dairy section.

When the customer stays in an area for a predetermined time or more, the determination unit 101 may determine that the customer is in the area. For example, in a case of determining that the customer is in the confectionery section and determining that the total amount of purchasing commodities is equal to or more than 2000 yen, the determination unit 101 determines that the coupon issuance condition for “Zoo cookie” is satisfied. The notification unit 102 may notify that a coupon is issued by going to a predetermined area in the store.

By setting the total amount of purchasing commodities of the customer and the location of a sales section where the target commodity of the coupon is displayed as the coupon issuance condition, the store can promote the sales of the commodity in the sales section and can expect an increase in the average customer spend.

When the coupon issuance condition includes that the customer is in a predetermined area in the store, the issuance condition may not include the total amount of purchasing commodities. That is, for example, the coupon may be issued according to the location of the customer regardless of the total amount of purchasing commodities.

[Modification: Setting of Notification Condition]

When the customer is notified of many coupons at a time, information cannot be effectively provided to the customer. In order to solve this, a notification condition when giving a notification of information regarding a coupon may be provided. Different notification conditions may be set for each coupon. The determination unit 101 determines whether the notification condition is satisfied. The notification unit 102 gives a notification of the information regarding the coupon when it is determined that the notification condition is satisfied. The information regarding the coupon is, for example, that the coupon has been issued or a notification the coupon issuance condition. For example, the notification unit 102 notifies the customer of the issuance condition of the coupon for which the issuance condition is not satisfied and the notification condition is satisfied.

FIG. 14 is a diagram illustrating an example of other coupon information according to the present modification. The coupon information illustrated in FIG. 14 is associated with a coupon notification condition in addition to the target commodity, the discount amount, and the issuance condition of the coupon illustrated in FIG. 7. The coupon notification condition is the location, for example, the sales section where the coupon target commodity is displayed.

The determination unit 101 receives the location of the customer in the store by any method, and determines whether the customer has entered a predetermined area in the store. For example, the determination unit 101 determines whether the location of the customer in the store satisfies the notification condition. The notification unit 102 gives a notification of the issuance condition when the customer enters a predetermined area in the store. For example, the notification unit 102 gives a notification of the issuance condition when the location of the customer terminal in the store is a predetermined location.

By setting the notification condition, in the example of FIG. 14, the customer terminal 12 is notified of the information regarding the coupon when the customer is in the dairy section. The information regarding the coupon at this time is the content that a coupon in which “tasty milk” is discounted by 20 yen is issued on condition that the total amount of purchasing commodities of the customer is equal to or more than 2000 yen.

The notification condition is not limited to the location, but may be, for example, the total amount.

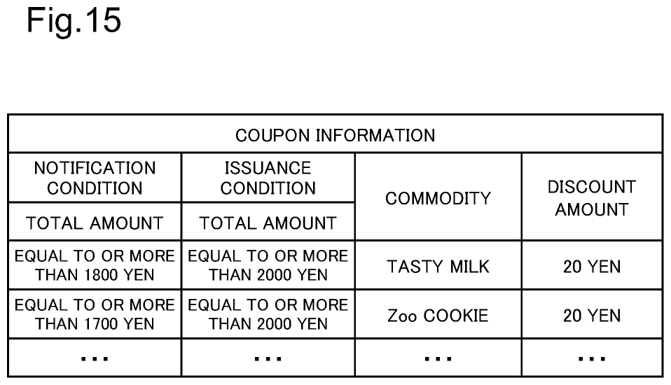

FIG. 15 is a diagram illustrating an example of other coupon information according to the present modification. The coupon information illustrated in FIG. 15 is an example in which the notification condition illustrated in FIG. 14 is changed from the location to the total amount. In the example of FIG. 14, a predetermined threshold amount (1800 yen) lower than the total amount (2000 yen) of purchasing commodities of the customer, which is a coupon issuance condition, is set as the notification condition, and when the total amount of the customer exceeds the threshold amount, the customer terminal 12 is notified of the information regarding the coupon. The information regarding the coupon at this time is the content that a coupon in which “tasty milk” is discounted by 20 yen is issued when the total amount of purchasing commodities of the customer is equal to or more than 2000 yen.

The determination unit 101 determines whether the total amount of the registered commodities satisfies the notification condition. The notification unit 102 gives a notification of the coupon issuance condition when the total amount of registered commodities is between the total amount of the issuance condition and a predetermined first amount smaller than the total amount of the issuance condition.

By setting the predetermined threshold amount short of the total amount of purchasing commodities of the customer, which is a coupon issuance condition, as the coupon notification condition, the store can promote the sales of the commodity and can expect an increase in the average customer spend.

The notification condition may be a notification condition using a difference between the total amount of purchasing commodities serving as the coupon issuance condition and the price of the coupon target commodity in addition to the total amount of purchasing commodities. For example, when the coupon issuance condition is that the total amount of purchasing commodities is 2000 yen and the price of the coupon target commodity is 250 yen, the difference of 1750 yen may be used as the notification condition of the predetermined threshold amount.

The determination unit 101 determines whether the difference between the total amount of the registered commodities and the total amount of the issuance condition satisfies the notification condition. The notification unit 102 gives a notification of the coupon issuance condition when the difference between the total amount of the registered commodities and the total amount of the issuance condition is a predetermined amount.

[Modification: Processing in Case where Commodity is Deregistered]

When the commodity is deregistered, the determination unit 101 may determine whether the total amount satisfies the issuance condition of the issued coupon. Specifically, when the commodity is deregistered, the POS server 11 transmits the purchasing commodity list to the coupon notification device 10. When the total amount of purchasing commodities, which is a coupon issuance condition, returns to an unachieved state due to the deregistration of the commodity, the notification unit 102 may notify the customer that the coupon is no longer applied.

The determination unit 101 may determine whether the issuance condition is satisfied in the case of deregistration when a pre-operation for deregistering the commodity is started. For example, the determination unit 101 may determine that a state in which the total amount satisfies the issuance condition is changed to a state in which the total amount does not satisfy the issuance condition. In a case where the issuance condition is not satisfied due to the deregistration, the notification unit 102 notifies that the issuance of the coupon is canceled due to the deregistration. The notification unit 102 may notify the customer that the issuance condition will not be satisfied due to the deregistration before the operation of deregistering the commodity is completed. With such a notification, there is a possibility that the customer cancels the operation of deregistering the commodity.

In a case where the commodity that has been deregistered is a target commodity of the coupon, the notification unit 102 may give a notification of the coupon issuance condition for a target commodity different from the deregistered commodity. That is, the notification unit 102 does not recommend the purchase again for the commodity that has been deregistered after being registered once. With such a notification, the notification unit 102 can give a notification of a coupon for a commodity that is more probable to be purchased as a target commodity.

[Modification: Shopping by a Plurality of People]

When shopping in a group of a plurality of people, it is assumed that one representative performs checkout. In this case, the coupon may be issued based on the total amount of all the commodities acquired by a group member.

First, the information processing system 1 performs association of group members and setting of a representative. All the commodities acquired by the group members are registered in association with the representative. That is, the commodities acquired by the group members are registered in one purchasing commodity list. The coupon notification device 10 may notify each group member of a coupon or may notify only the representative.

[Modification: Checkout Using Checkout Device]

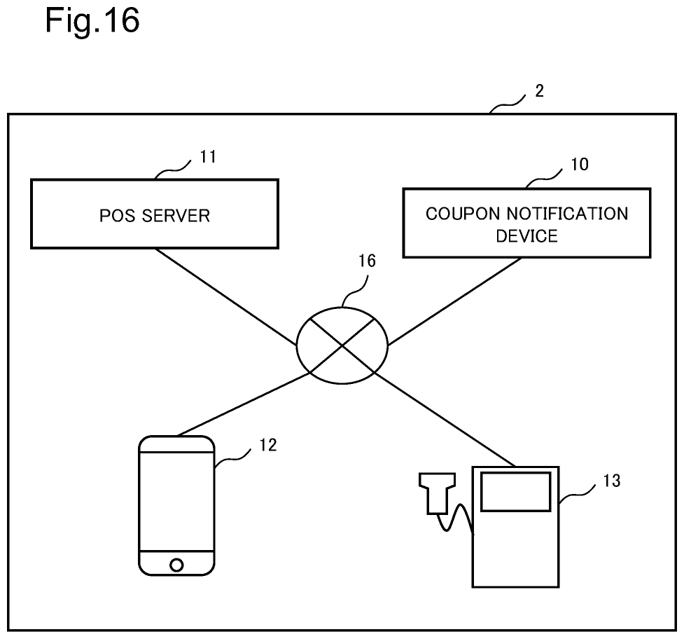

In the first example embodiment, the case where electronic payment is performed using the customer terminal 12 has been described, but the checkout may be performed using a checkout device. FIG. 16 is a diagram illustrating a configuration example of an information processing system 2 according to the present modification. The information processing system 2 is different from the information processing system 1 according to the first example embodiment in that the information processing system 2 includes a checkout device 13.

The checkout device 13 receives checkout information from the POS server 11 or the customer terminal 12, and performs checkout by either cash payment or electronic payment. When the checkout device 13 receives the checkout information from the POS server 11, the customer terminal 12 may cause the display unit 1230 to display a checkout code. The checkout code includes information for specifying the checkout information. The checkout code may be the customer ID, the identifier of the customer terminal 12, or the member ID. The checkout device 13 receives, from the POS server 11, the checkout information related to the checkout code read from customer terminal 12.

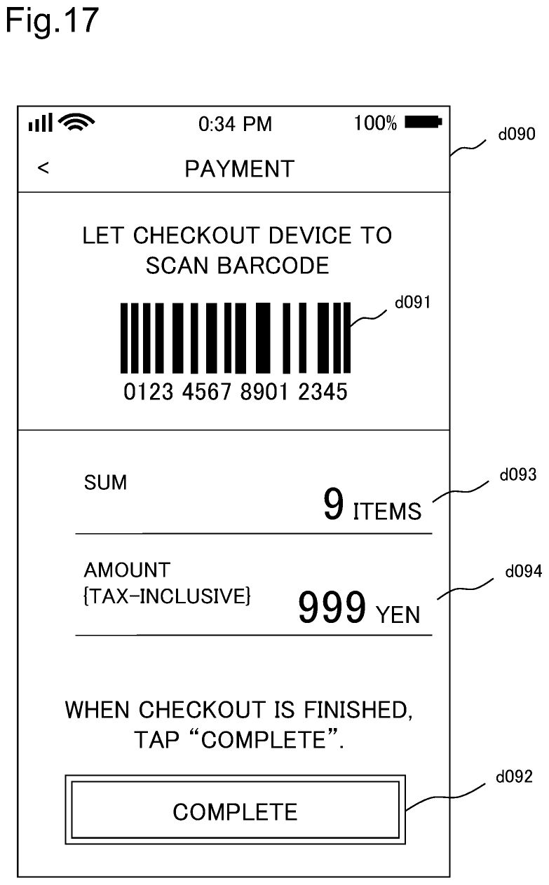

FIG. 17 is a diagram illustrating an example of a checkout code. For example, a screen d090 of FIG. 17 includes a display field d091 of the checkout code, a total quantity display field d093, and a payment amount display field d094. The total purchase quantity of commodities purchased by the customer is displayed in the total quantity display field d093. In the payment amount display field d094, for example, the tax-inclusive total amount of commodities to be purchased by the customer after the coupon is applied is displayed. The screen d090 has a completion button d092 to be tapped after the checkout ends.

In the case of performing cash payment, the checkout device 13 performs checkout based on money inserted into an insertion port provided in the checkout device 13. The type of the electronic payment is not particularly limited. When the checkout device is used, the electronic money payment described above includes, for example, barcode payment or Quick Response code (QR code (registered trademark)) payment. In a case where credit card payment included in electronic payment is used, the checkout device 13 communicates with a payment server, which is not illustrated, using, for example, credit information acquired via a reading device provided in the checkout device 13, and performs checkout.

[Modification: Registration of Commodity by Image Recognition]

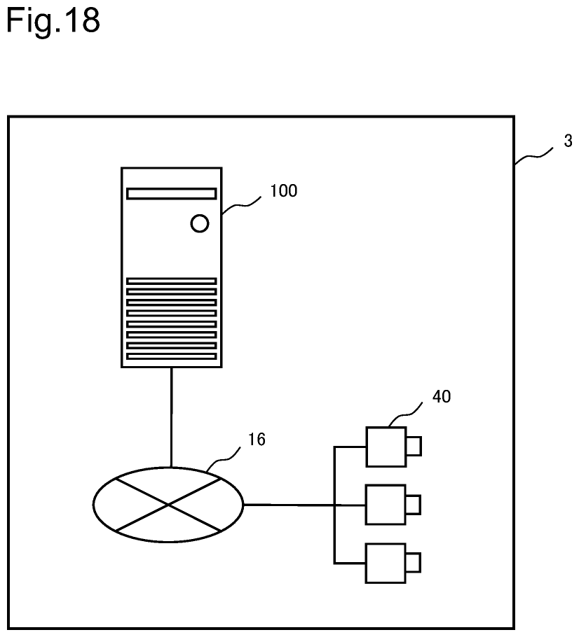

In the first example embodiment, the case where the customer terminal 12 is used for commodity registration has been described. In the present modification, a case where the commodity acquired by the customer is registered based on a video of the customer in the store will be described. FIG. 18 is a diagram illustrating a configuration example of an information processing system 3 according to the present modification.

The information processing system 3 includes a server 100 and one or more cameras 40. The server 100 and the cameras 40 are connected via the communication network 16. The server 100 has the functions of the coupon notification device 10 and the POS server 11 according to the first example embodiment.

The cameras 40 are an imaging device. The camera 40 includes, for example, an image sensor such as a charge coupled device (CCD) sensor or a complementary metal oxide semiconductor (CMOS) sensor.

The cameras 40 are provided at a plurality of locations in a store, such as near an entrance of the store, a place where commodities are displayed in the store (hereinafter, also referred to as a sales section), or near an exit of the store. The camera 40 provided near the entrance captures an image of the customer entering the store. The camera 40 provided at the sales section captures images of the customer and the commodity present at the sales section. The camera 40 provided near the exit captures an image of the customer leaving the store. The store is provided with a number of cameras 40 arranged to be capable of capturing images of customers and commodities present anywhere in the store.

The camera 40 transmits image data including the captured image to the POS server 11. The POS server 11 specifies the customer who has acquired a commodity and the acquired commodity based on the image captured by the camera 40 and generates a purchasing commodity list for each customer. The commodity specified using the image is one example embodiment of commodities registered in association with the customer. The coupon notification device 10 transmits the information regarding the coupon to the customer terminal 12 owned by the customer using the contact of the customer or the ID of the customer terminal 12 stored in the POS server 11.

The POS server 11 performs checkout processing on the registered commodity. For example, the POS server 11 specifies a customer who is a customer leaving the store, and performs checkout based on the purchasing commodity list of the customer.

[Modification: Various Types of Coupons]

A plurality of coupons may be applied to one purchasing commodity list. The coupon DB 118 may include coupon information of coupons for which the total amount as the issuance condition is different for each target commodity. The coupon DB 118 may include coupon information of a coupon for further price reduction of the target commodity according to the total amount. After the issuance condition of a first coupon is fulfilled, the notification unit 102 gives a notification of the issuance condition of a second coupon for which the total amount as the issuance condition is higher. The customer who has received the notification further adds a commodity to satisfy the issuance condition of a higher total amount.

[Modification: Coupon Notification Method]

In the first example embodiment, the case where the notification unit 102 of the coupon notification device 10 notifies the customer terminal 12 and the display unit 1230 displays the information regarding the coupon has been described. In the present modification, the information processing system 1 notifies the customer by another method.

For example, the output unit 123 of the customer terminal 12 may output information regarding a coupon by voice. The output unit 123 may inform the customer that the notification has been received from the notification unit 102 by sound or vibration.

The customer terminal 12 may not be used for the notification to the customer. For example, the notification unit 102 causes a display provided in a shopping area of the store to display the information regarding the coupon. The shopping area is an area where commodities are displayed. The notification unit 102 may specify the location of the customer using a known technique and cause a display near the customer to display information regarding the coupon. The type of the display is not particularly limited. The display includes, for example, a digital signage, an electronic shelf label, and a video projected by a projector. The notification unit 102 may notify the customer by voice using a speaker.

### Second Example Embodiment

Next, an information processing device 50 according to a second example embodiment will be described with reference to the drawings. In the second example embodiment, a basic configuration of the contents described in the first example embodiment will be described. The coupon notification device 10 according to the first example embodiment is one example embodiment of the information processing device 50 according to the second example embodiment. The information processing device 50 may include some or all of the functions related to the POS server 11.

[Configuration]

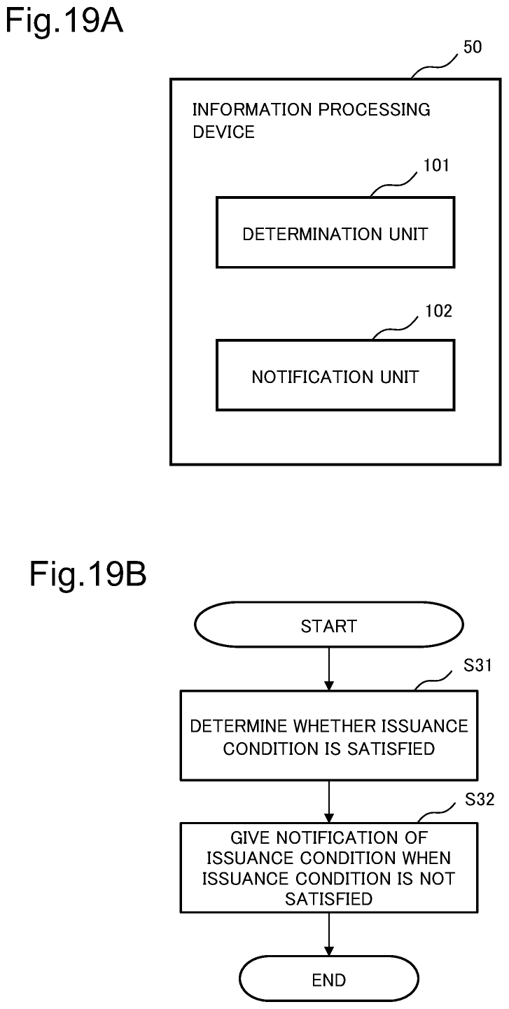

FIG. 19A is a diagram illustrating an example of a basic configuration of the information processing device 50 according to the second example embodiment. The information processing device 50 is communicably connected to another device that registers a commodity in association with a customer. For example, the information processing device 50 is communicably connected to the customer terminal 12 and the POS server 11 according to the first example embodiment.

This information processing device 50 includes the determination unit 101 and the notification unit 102. The determination unit 101 and the notification unit 102 are one example embodiment of a determination means and a notification means, respectively. The determination unit 101 determines whether the total amount of commodities registered in association with the customer satisfies the coupon issuance condition for a target commodity.

When the total amount of registered commodities does not satisfy the coupon issuance condition, the notification unit 102 notifies the customer, before the checkout of the commodities is completed, of the coupon issuance condition. Before the checkout is completed is, for example, a period during which commodities can be additionally registered. When the coupon is applied, the price of a registered target commodity is lowered. Therefore, the customer can purchase the target commodity at a lower price than before applying the coupon.

[Operation]

FIG. 19B is a flowchart illustrating a basic operation of the information processing device 50. First, the determination unit 101 determines whether the total amount of commodities registered in association with the customer satisfies the coupon issuance condition for a target commodity (step S31). When the total amount of registered commodities does not satisfy the coupon issuance condition, the notification unit 102 notifies the customer, before the checkout of the commodities is completed, of the coupon issuance condition (step S32).

[Effects]

According to the second example embodiment, it is possible to promote sales of commodities that the store wants to sale and increase the average customer spend. This is because when the total amount of commodities registered in association with the customer does not satisfy the coupon issuance condition for the target commodity, the notification unit 102 notifies the customer, before the checkout of the commodities is completed, of the coupon issuance condition. This is because it is possible to encourage the customer to add a commodity in accordance with the coupon issuance condition notified.

(Hardware Configuration)

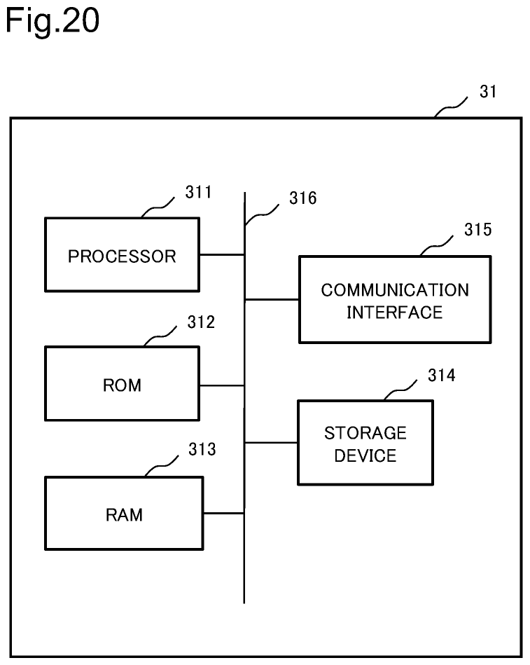

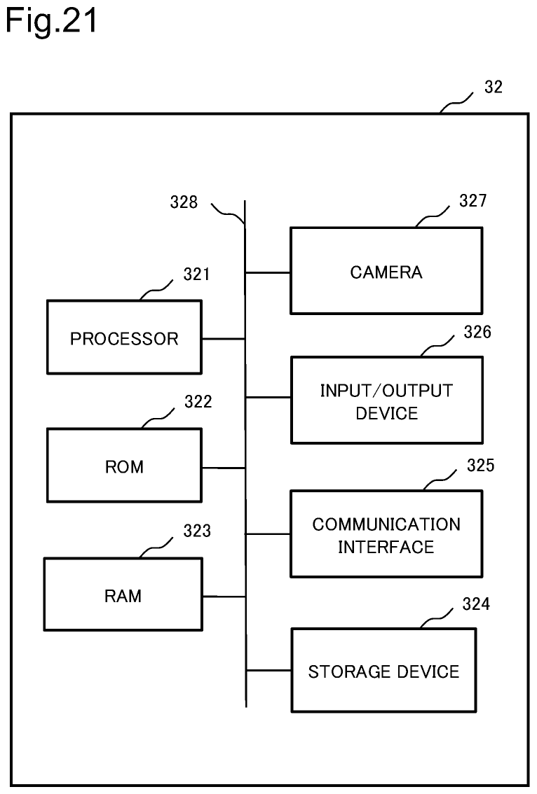

Thus, the description of each example embodiment ends. Next, hardware configurations of the coupon notification device 10, the POS server 11, and the customer terminal 12 will be described. FIGS. 20 and 21 are explanatory diagrams illustrating a hardware configuration example of the system.

In each of the above-described example embodiments, each component of the coupon notification device 10, the POS server 11, and the information processing device 50 indicates a block on a function basis. Some or all of components may be achieved by any combination of the computer 31 and a program. There are various modifications for the method of achieving the coupon notification device 10 and the POS server 11. For example, the coupon notification device 10 and the POS server 11 may be achieved by a single computer 31. Each of a plurality of components included in each device may be achieved by different computers 31.

A hardware configuration example of the computer 31 illustrated in FIG. 20 will be described. The computer 31 includes, for example, a processor 311, ROM 312, RAM 313, a storage device 314, and a communication interface 315. Configuration units of the computer 31 are connected via a bus 316.

Next, a hardware configuration example of the customer terminal 32 illustrated in FIG. 21 will be described. The customer terminal 32 is an example in which the customer terminal 12 described in the first example embodiment is achieved by a computer. The customer terminal 32 includes a processor 321, ROM 322, RAM 323, a storage device 324, a communication interface 325, an input/output device 326, and a camera 327. Configuration units of the customer terminal 32 are connected via a bus 328.

The processor 311 or 321 controls the entire computer 31 or customer terminal 32. Examples of the processors 311 and 321 include a central processing unit (CPU), a digital signal processor (DSP), and the like. The computer 31 and the customer terminal 32 include, as storage units, the ROM 312 and 322, the RAM 313 and 323, the storage devices 314 and 324, and the like. Examples of the storage devices 314 and 324 include a semiconductor memory such as flash memory, an HDD, and an SSD. For example, the storage devices 314 and 324 store an operating system (OS) program, an application program, and the like. Alternatively, the ROM 312 and 322 store an application program. Then, the RAM 313 and 323 are used as work areas of the processors 311 and 321.

The processors 311 and 321 load programs stored in the storage devices 314 and 324, the ROM 312 and 322, and the like. Then, the processors 311 and 321 execute each processing coded in the program. The processors 311 and 321 may download various programs via a communication network. The processor 311 or 321 functions as a part or all of the computer 31 or the customer terminal 32. Then, the processors 311 and 321 may execute processing or instructions in the illustrated flowchart based on the program.

The communication interfaces 315 and 325 are connected to a communication network such as a local area network (LAN) or a wide area network (WAN) through a wireless or wired communication line. As a result, the computer 31 and the customer terminal 32 are connected to an external device or an external computer via the communication network. The communication interfaces 315 and 325 control interfaces between the communication network and the inside of the computer 31 and the customer terminal 32. Then, the communication interfaces 315 and 325 control input and output of data from an external device or an external computer.

The hardware configurations illustrated in FIGS. 20 and 21 are an example. Those other than the components illustrated in the drawings may be added, or some components may not be included. For example, the computer 31 may have an input device such as a keyboard, a mouse, and a physical button.

Thus, the description of the hardware configurations of the devices ends. There are various modifications for the method of achieving each device. For example, the system may be achieved by any combination of a computer and a program different for each component. A plurality of components included in each device may be achieved by any combination of one computer and a program.

Some or all of the components of the system may be achieved by an application-specific circuit. A part or all of the system may be achieved by a general-purpose circuit including a processor such as a field programmable gate array (FPGA). A part or all of the system may be achieved by a combination of an application-specific circuit, a general-purpose circuit, or the like. These circuits may be a single integrated circuit. Alternatively, these circuits may be divided into a plurality of integrated circuits. Then, the plurality of integrated circuits may be configured by being connected via a bus or the like.

In a case where some or all of the components of the devices are achieved by a plurality of computers, circuits, and the like, the plurality of computers, circuits, and the like may be arranged in a centralized manner or may be arranged in a distributed manner.

The methods described in the example embodiments can be achieved by execution by the coupon notification device, the POS server, or the customer terminal. The methods are achieved by a computer such as the coupon notification device, the POS server, or the customer terminal executing the program prepared in advance. The program is recorded on a computer-readable recording medium such as an HDD, an SSD, a flexible disk, an optical disk, a flexible disk, a magneto-optical disk, or USB memory. Then, the present program is executed by being read from the recording medium by the computer. The program may be distributed via the communication network.

The functions of the components of the system according to each example embodiment described above may be achieved as hardware like the system of the computer illustrated in FIGS. 20 and 21. Alternatively, each component may be achieved by a computer device or firmware based on program control.

While the present invention has been described with reference to each example embodiment, the present invention is not limited to the example embodiments described above. Example embodiments to which various changes that can be understood by those skilled in the art are applied within the scope of the present invention can be included in the configuration and details of the present invention. The present invention can include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order of executing the plurality of operations. Therefore, when each example embodiment is implemented, the order of the plurality of operations can be changed within a range that does not interfere with the content.

Some or all of the above example embodiments may be described as the following supplementary notes, but are not limited to the following.

(Supplementary Note 1)

An information processing device including:
a determination means that determines whether a total amount of commodities registered in association with a customer satisfies a coupon issuance condition for a target commodity; and
a notification means that notifies the customer before checkout of the commodities is completed, of the coupon issuance condition when the issuance condition is not satisfied.

(Supplementary Note 2)

The information processing device according to supplementary note 1, in which a coupon of the target commodity lowers a price of the target commodity among the registered commodities.

(Supplementary Note 3)

The information processing device according to supplementary note 1 or 2, in which the registered commodities are commodities registered by the customer using a customer terminal during shopping, and the notification means notifies the customer terminal of the issuance condition.

(Supplementary Note 4)

The information processing device according to any one of supplementary notes 1 to 3, in which the notification means notifies that the coupon is issued by going to a predetermined area in a store.

(Supplementary Note 5)

The information processing device according to any one of supplementary notes 1 to 4, in which the notification means gives a notification of the issuance condition regarding the total amount set for each attribute of the customer.

(Supplementary Note 6)

The information processing device according to any one of supplementary notes 1 to 5, in which a target commodity associated with the coupon issuance condition is set according to an attribute of the customer.

(Supplementary Note 7)

The information processing device according to any one of supplementary notes 1 to 6, in which the notification means gives a notification of the issuance condition when the customer enters a predetermined area in a store.

(Supplementary Note 8)

The information processing device according to any one of supplementary notes 1 to 7, in which the notification means gives a notification of the coupon issuance condition when the total amount of the registered commodities is between a total amount of the issuance condition and a smaller predetermined first amount.

(Supplementary Note 9)

The information processing device according to any one of supplementary notes 1 to 8, in which the notification means gives a notification of the coupon issuance condition when a difference between the total amount of the registered commodities and the total amount of the issuance condition is a predetermined amount.

(Supplementary Note 10)

The information processing device according to any one of supplementary notes 1 to 9, in which
the determination means determines whether the issuance condition is satisfied by deregistration when a pre-operation for deregistering any of the commodities is started, and
the notification means notifies that issuance of the coupon is canceled by deregistration in case where the issuance condition is not satisfied.

(Supplementary Note 11)

The information processing device according to any one of supplementary notes 1 to 10, in which
when a commodity the association with the customer of which is canceled is a target commodity associated with the issuance condition, the notification means gives a notification of a coupon issuance condition for a target commodity different from the canceled commodity.

(Supplementary Note 12)

An information processing system including:
a customer terminal that is used by a customer and reads identification information of a commodity;
a POS server that receives the identification information from the customer terminal and registers the commodity in association with the customer; and
a coupon notification device that notifies the customer terminal, in which the coupon notification device includes: a determination means that determines whether a total amount of commodities registered in association with the customer satisfies a coupon issuance condition for a target commodity; and a notification means that notifies the customer terminal of the customer before checkout of the commodities is completed, of the coupon issuance condition when the issuance condition is not satisfied, and
the customer terminal superimposes information regarding the coupon on a list screen of the registered commodities and outputs the information to the customer terminal.

(Supplementary Note 13)

The information processing system according to supplementary note 12, in which the customer terminal outputs a notification of issuance of the coupon and a notification of the issuance condition in different forms.

(Supplementary Note 14)

A notification provision method including:
determining whether a total amount of commodities registered in association with a customer satisfies a coupon issuance condition for a target commodity; and
notifying the customer before checkout of the commodities is completed, of the coupon issuance condition when the issuance condition is not satisfied.

(Supplementary Note 15)

A computer-readable non-transitory recording medium that records a program for causing a computer to function as:
a determination means that determines whether a total amount of commodities registered in association with a customer satisfies a coupon issuance condition for a target commodity; and
a notification means that notifies the customer before checkout of the commodities is completed, of the coupon issuance condition when the issuance condition is not satisfied.

(Supplementary Note 16)

An information processing device including:
a determination means that determines whether a total amount of commodities registered on a portable terminal by an operation of a customer satisfies a coupon issuance condition for a target commodity; and
a notification means that notifies the customer before checkout of the commodities is completed, of the coupon issuance condition when the issuance condition is not satisfied.

(Supplementary Note 17)

A notification provision method including:
determining whether a total amount of commodities registered on a portable terminal by an operation of a customer satisfies a coupon issuance condition for a target commodity; and
notifying the customer before checkout of the commodities is completed, of the coupon issuance condition when the issuance condition is not satisfied.

(Supplementary Note 18)

A computer-readable non-transitory recording medium that records a program for causing a computer to function as:
a determination means that determines whether a total amount of commodities registered on a portable terminal by an operation of a customer satisfies a coupon issuance condition for a target commodity; and
a notification means that notifies the customer before checkout of the commodities is completed, of the coupon issuance condition when the issuance condition is not satisfied.

### REFERENCE SIGNS LIST

1, 2, 3 information processing system
10 coupon notification device
101 determination unit
102 notification unit
11 POS server
111 list generation unit
113 sales management unit
114 storage unit
115 member DB
116 commodity DB
117 purchasing commodity list DB
118 coupon DB
119 sales DB
12 customer terminal
121 acquisition unit
123 output unit
13 checkout device
16 communication network
40 camera
100 server

What is claimed is:

1. An information processing device comprising:
at least one memory configured to store instructions; and
at least one processor configured to execute the instructions to:
determine whether a total amount of commodities registered on a portable terminal by an operation of a customer satisfies a coupon issuance condition for a target commodity; and
notify the customer, before checkout of the commodities is completed, of the coupon issuance condition when the issuance condition is not satisfied.

2. The information processing device according to claim 1, wherein
a coupon of the target commodity lowers a price of the target commodity among the registered commodities.

3. The information processing device according to claim 1, wherein
the registered commodities are commodities registered by the customer using a portable terminal during shopping, and
the at least one processor is further configured to execute the instructions to:
notify the portable terminal of the coupon issuance condition.

4. The information processing device according to claim 1, wherein the at least one processor is further configured to execute the instructions to:
notify the coupon issuance condition regarding the total amount set for each attribute of the customer.

5. The information processing device according to claim 1, wherein the at least one processor is further configured to execute the instructions to:
notify the coupon issuance condition when the customer enters a predetermined area in a store.

6. The information processing device according to claim 1, wherein the at least one processor is further configured to execute the instructions to:
notify the coupon issuance condition when the total amount of the registered commodities is between a total amount of the issuance condition and a smaller predetermined first amount.

7. The information processing device according to claim 1, wherein the at least one processor is further configured to execute the instructions to:
determine whether the coupon issuance condition is satisfied by deregistration when a pre-operation for deregistering any of the commodities is started, and
notify that issuance of the coupon is canceled by deregistration in case where the issuance condition is not satisfied.

8. The information processing device according to claim 1, wherein the at least one processor is further configured to execute the instructions to:
when a deregistered commodity is a target commodity associated with the coupon issuance condition,
notify a coupon issuance condition for a target commodity different from the deregistered commodity.

9. A notification provision method comprising:
determining whether a total amount of commodities registered on a portable terminal by an operation of a customer satisfies a coupon issuance condition for a target commodity; and
notifying the customer before checkout of the commodities is completed, of the coupon issuance condition when the issuance condition is not satisfied.

10. (canceled)

11. An information processing device comprising:
at least one memory configured to store instructions; and
at least one processor configured to execute the instructions to:
determine whether a total amount of commodities registered in association with a customer satisfies a coupon issuance condition for a target commodity; and
notify the customer, before checkout of the commodities is completed, of the coupon issuance condition when the issuance condition is not satisfied.

12. (canceled)

13. (canceled)
